(19) United States
(12) Patent Application Publication
(10) Pub. No.: US 2016/0119614 A1
(43) Pub. Date: Apr. 28, 2016

(54) DISPLAY APPARATUS, DISPLAY CONTROL METHOD AND COMPUTER READABLE RECORDING MEDIUM RECORDING PROGRAM THEREON

(71) Applicant: CASIO COMPUTER CO., LTD., Tokyo (JP)

(72) Inventors: Hiroki Masuda, Tokyo (JP); Akihito Iwadate, Tokyo (JP)

(21) Appl. No.: 14/853,031

(22) Filed: Sep. 14, 2015

(30) Foreign Application Priority Data
Oct. 23, 2014 (JP) 2014-216714

(51) Int. Cl. H04N 13/04; H04N 5/232

(52) U.S. Cl. CPC H04N 13/0459; H04N 5/23229

(57) ABSTRACT

A display apparatus of an embodiment of the present invention includes a display unit, an illumination condition acquiring unit for acquiring an illumination condition including at least the direction of an external light source with respect to the display unit, a corrected image generating unit for generating a corrected image based on the illumination condition and an image to be displayed, and a display control unit for performing control to display the corrected image on the display unit.

### CROSS-REFERENCE TO RELATED APPLICATIONS

This application is based upon and claims the benefit of priority under 35 USC 119 of Japanese Patent Application No. 2014-216714 filed on Oct. 23, 2014, the entire disclosure of which is incorporated herein by reference in its entirety for all purposes.

### BACKGROUND OF THE INVENTION

1. Field of the Invention

The present invention relates to a display apparatus, a display control method, and a computer readable recording medium for recording a program thereon.

2. Description of the Related Art

As a conventional technology, Japanese Patent Application Laid-Open Publication No. 2011-150221 published on Aug. 4, 2011 discloses a display apparatus for projecting an image of a person onto a screen which is a plate formed in the shape of a human being to provide a variety of information in order to give viewers a strong impression.

There is a need for ways of displaying an image in which an uneven object such as a person looks more three-dimensional by display apparatuses such as one described in the above patent document to give viewers an impression of reality.

### SUMMARY OF THE INVENTION

Thus, an object of the present invention is to provide a display apparatus, a display control method, and a computer readable recording medium for recording a program for displaying an image with a three-dimensional effect.

In order to achieve the above object, an embodiment of the present invention provides a display apparatus including a display section, an illumination condition acquiring section configured to acquire an illumination condition including at least the direction of an external light source with respect to the display section, a corrected image generating section configured to generate a corrected image based on the illumination condition and an image to be displayed, and a display control section configured to perform control to display the corrected image on the display section.

In order to achieve the above object, an embodiment of the present invention provides a display control method performed by a display apparatus including acquiring an illumination condition including at least the direction of a light source existing outside the display apparatus, determining a shadow part of an image to be displayed which is to be shadowed based on the illumination condition, generating a shadowed image by adding a shadow to the shadow part of the image to be displayed, and displaying the shadowed image.

In order to achieve the above object, an embodiment of the present invention provides a non-transitory computer-readable recording medium for recording a program readable by a computer. The program causes a computer included in a display apparatus to perform steps of acquiring an illumination condition including at least the direction of a light source existing outside the display apparatus, determining a shadow part of an image to be displayed which is to be shadowed based on the illumination condition, generating a shadowed image by adding a shadow to the shadow part of the image to be displayed, and displaying the shadowed image. The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention will more sufficiently be understood by the following detailed description and the accompanying drawings.

Here:

FIG. 1 is a perspective view of a display apparatus according to a first embodiment of the present invention when viewed from above at a tilt angle.

FIG. 2 is a perspective view of the display apparatus according to the first embodiment when viewed nearly from the front.

FIG. 3 is a perspective view showing an internal configuration of the display apparatus according to the first embodiment.

FIG. 4 is a block diagram showing a main control configuration of the display apparatus according to the first embodiment.

FIG. 5 is a flow chart for showing how the display apparatus according to the first embodiment works.

FIG. 6A shows a situation in which the display apparatus according to the first embodiment is used.

FIG. 6B shows an example of outputs of illuminance sensors.

FIG. 6C shows a shadowed image.

FIGS. 7A and 7B show examples of outputs of the illuminance sensors.

FIG. 8 is a flow chart for showing how a display apparatus according to a second embodiment of the present invention works.

FIGS. 9A to 9C show examples of shadowed images provided by a display apparatus according to a third embodiment of the present invention.

FIG. 10 shows a display system including a display apparatus according to a fourth embodiment of the present invention.

FIG. 11 is a flow chart for showing how the display apparatus according to the fourth embodiment works.

FIG. 12 is a flow chart for showing how a server of the fourth embodiment works.

### DETAILED DESCRIPTION OF THE PREFERRED EMBODIMENT

Hereinafter, embodiments of the present invention will be described with reference to the accompanying drawings. The embodiments described below includes various features technically desirable in practicing the present invention, but the scope of the invention is not intended to be limited to the embodiments and illustrated examples.

### First Embodiment

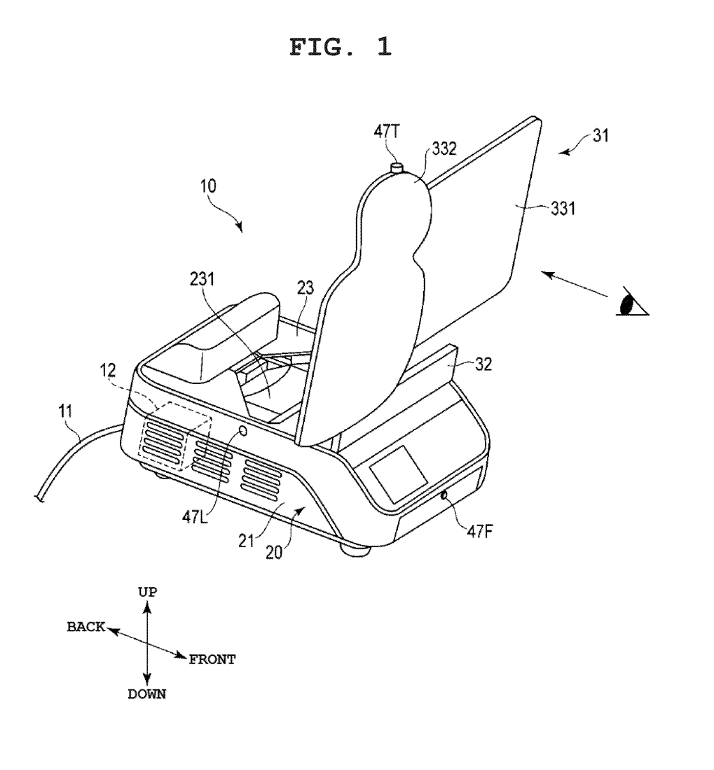

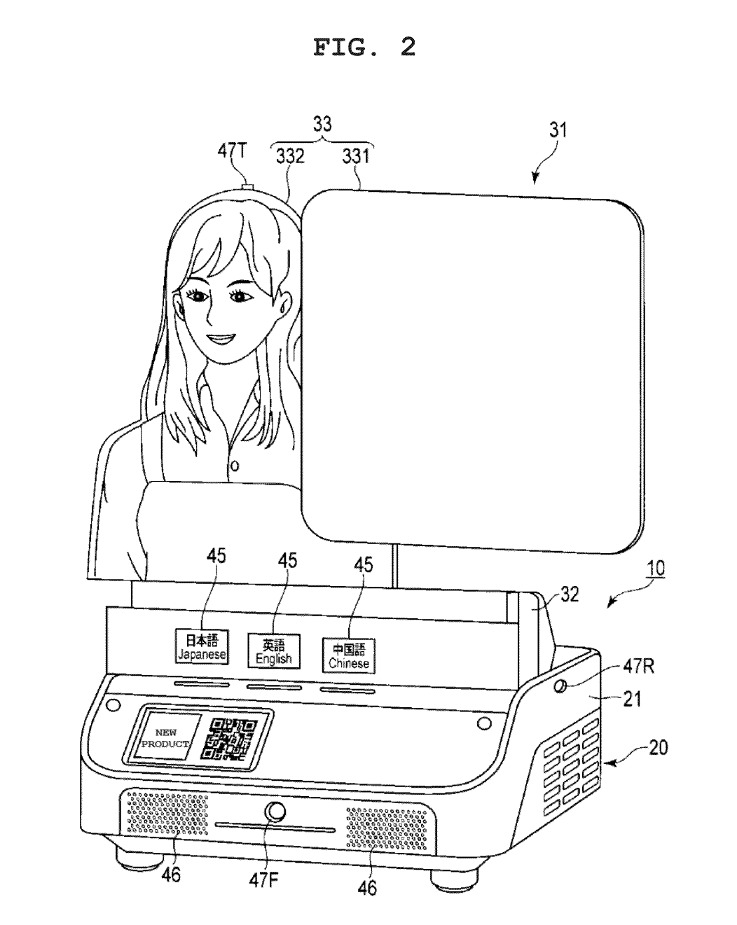

First, a display apparatus 10 according to a first embodiment of the present invention is described with reference to FIGS. 1 to 4.

For example, the display apparatus 10 may be installed in a store or an exhibit hall to play back contents such as an explanation of a product, guide information, and a survey, or in a nursing facility to play back contents for setting questions for brain activation. The display apparatus 10 can be used for various purposes without limitation.

Further, in the present embodiment, a person's image is shown on a screen unit 31 which suits playback of contents for providing any explanation or guide and has the shape of the person, as shown in FIG. 1. However, the shape of the screen unit 31 is not limited thereto.

The display apparatus 10 includes a case 20 which is nearly rectangular in overall shape.

The display apparatus 10 uses a common power source of the store or the exhibit hall as a prime power source and includes a power cord 11 including a plug (now shown in the drawings) for receiving supply of electric power from the common power source and an auxiliary power source (such as a battery) 12 which can be used when the power supply is cut off from the prime power source.

Further, the prime power source indicates a power adaptor of the display apparatus 10 and the like for making electric power supplied from the common power source suitable for driving the display apparatus 10.

The screen unit 31 is exchangeably installed on one end of the case 20 (on the right end in FIG. 1) via a screen installation unit 32. The screen unit 31 can be properly exchanged according to the contents.

In the following, the terms of “up (top)”, “front” and “rear (back)” indicates the upper side, the side of the screen unit 31, and the opposite side of the screen unit 31, respectively, when the case 20 is put on a desk, for example.

A button-type operating unit 45 and a voice output unit 46 for outputting voices, such as a speaker, are provided in the case 20 below the screen installation unit 32. Further, illuminance sensors 47T, 47F, 47B, 47L, and 47R are provided on the top of the screen unit 31, the front, the back, and the left and right sides of the case 20, respectively. Alternatively, the illuminance sensor 47T may be provided on the top of the case 20.

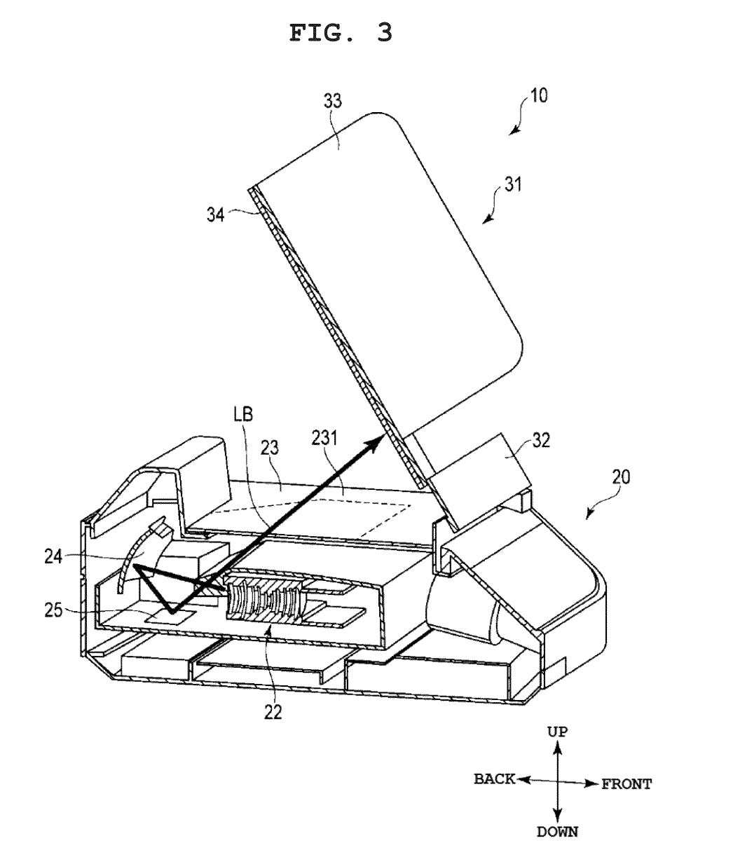

As shown in FIG. 3, the case 20 includes side panels 21 surrounding the front, the back, the left and right sides and an opening on the top. A panel 23 is provided to cover the opening and has a transparent part 231 for transmitting light at its center.

In the present embodiment, the inside of the case 20 cannot be seen through regions of the panel 23 other than the transparent part 231, for example, by black printing. However, the present invention is not limited thereto and the whole of the panel may be transparent.

As shown in FIG. 3, a projection unit 22 is provided for generating projection light and directing it toward the rear of the case 20 nearly in the middle of the inside of the case 20 so as to be placed below the back side of the screen unit 31.

A first mirror 24 having a concave reflective surface is provided in the rear of the case 20. The first mirror 24 reflects the projection light from the projection unit 22 toward a second mirror 25 having a flat reflective surface. Then, the projection light is reflected by the second mirror 25 toward the screen unit 31.

Thus, the projection light (an image) generated from the projection unit 22 is reflected by the first mirror 24 downwardly, reflected by the second mirror 25 upwardly, and then projected onto the screen unit 31 installed outside the case 20 through the transparent part 231 of the panel 23 (projection light LB). By this, the screen unit 31 receives the projection light directed from the projection unit 22 on its back side and displays it on its front side.

The screen unit 31 includes a diffuse transmission part 33 formed from a acrylic panel, for example, and a Fresnel screen 34 disposed on the back of the diffuse transmission part 33, as shown in FIG. 3.

The diffuse transmission part 33 includes a flat panel part 331 having the shape of a flat panel and a three-dimensional part 332 formed to protrude toward the front for a three-dimensional effect. The flat panel part 331 has a flat panel shape to increase visibility because it is an information providing unit for displaying a variety of information. The three-dimensional part 332 is hollow and its back is open. The projection light forming a person's image is projected onto the three-dimensional part 332. It is desirable to form the three-dimensional part 332 to have a three-dimensional shape more similar to a human being if reality is important. In addition, it is desirable to perform matt surface finish for a surface of at least a part of the diffuse transmission part 33. By the matt surface finish, external light is not easily reflected by the surface of the diffuse transmission part 33 which can prevent the image's visibility from being worsen.

The Fresnel screen 34 is in the shape of a panel and covers the whole of the back of the diffuse transmission part 33. More specifically, a cross section of one side of the Fresnel screen 34 facing the diffuse transmission part 33 which is a light emitting side is saw-toothed. The Fresnel screen 34 on the side of the projection unit 22 is planar in shape. However, the Fresnel screen 34 is not limited to this configuration. On the contrary, the Fresnel screen 34 on the side of the diffuse transmission part 33 may be planar in shape and a cross section of one side of the Fresnel screen 34 facing the projection unit 22 may be saw-toothed. Alternatively, cross sections of both sides of the Fresnel screen 34 may be saw-toothed.

The three-dimensional part 332 of the diffuse transmission part 33 and the Fresnel screen 34 are partially separated by a predetermined distance. The projection unit 22 includes a projection lens and the projection unit 22 and the screen unit 31 are disposed so that the screen unit 31 is disposed above an optical axis of the projection lens of the projection unit 22. In other words, the projection unit 22 includes a shift optical system disposed below the screen unit 31. Further, the Fresnel screen 34 is disposed to be nearly perpendicular to an optical axis of the projection light of the projection lens of the projection unit 22. The Fresnel screen 34 refracts the projection light LB projected from the projection unit 22 at a predetermined angle and converts it to parallel rays as a whole. Since a viewer views straight an image displayed on the screen unit 31, it is desired to make the viewer be able to visually recognize the image correctly from the position. For this, the Fresnel screen 34 is configured to convert the projection light LB to parallel rays nearly perpendicular to an imaginary plane straight facing the viewer.

Further, the Fresnel screen 34 does not necessarily need to convert the projection light LB to the parallel rays. In many cases, the viewer looks at the screen unit 31 from a point of view higher than it. Therefore, the projection light LB may be converted to rays slightly spreading close to the horizontal direction which is the direction of the eyes of the viewer (for example, 10° upwardly from a direction nearly perpendicular to the screen unit 31) by passing through the Fresnel screen 34.

As shown in FIGS. 1 to 3, the screen unit 31 is rotatably supported by the screen installation unit 32. It is possible to make the screen unit 31 stand when in use, and lay down the screen unit 31 toward the case 20 when out of use.

Thus, while moving the display apparatus 10, it is possible to lay down the screen unit 31 toward the case 20 and put it in the case 20 so that the screen unit 31 does not become a hindrance.

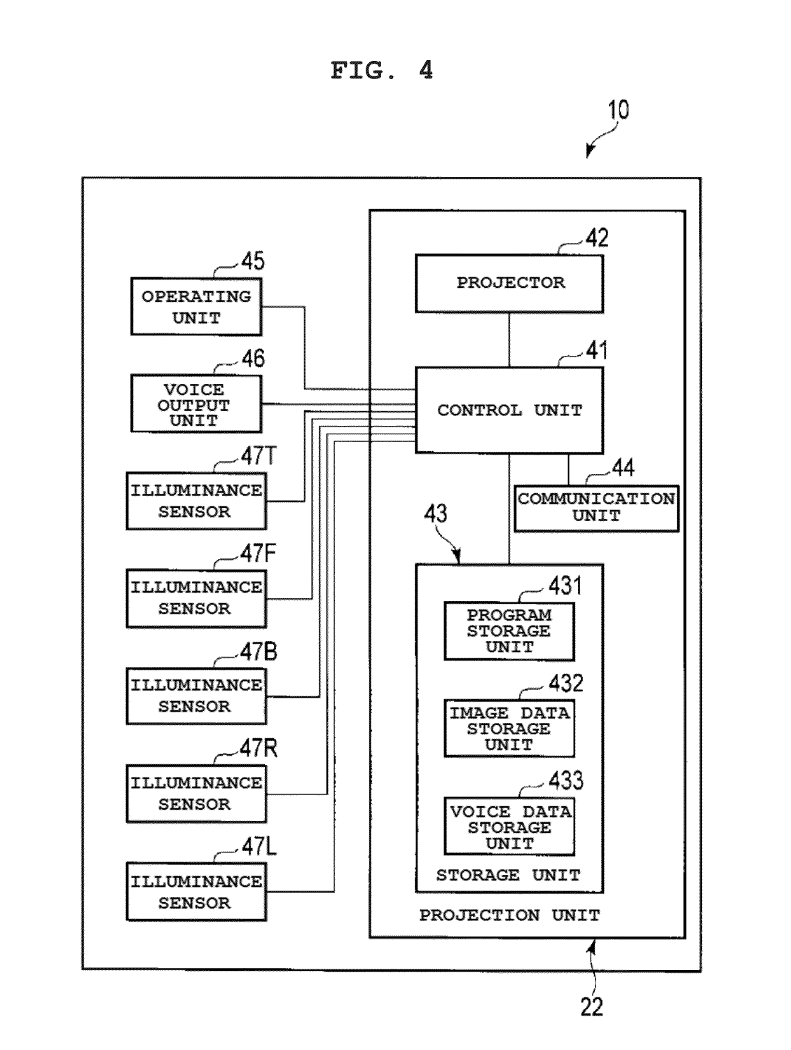

Next, a main configuration of the display apparatus 10 according to the first embodiment is described referring to a block diagram shown in FIG. 4.

The projection unit 22 mainly includes a control unit (an illumination condition acquiring unit, a determining unit and a corrected image generating unit) 41, a projector 42, a storage unit 43, and a communication unit 44. Each of the projector 42, a storage unit 43, and a communication unit 44 are connected to the control unit 41. Further, the operating unit 45, the voice output unit 46, and the illuminance sensors 47T, 47F, 47B, 47L, and 47R are connected to the control unit 41.

The control unit 41 includes a CPU for performing predetermined operations and/or controlling each unit by executing various programs stored in the storage unit 43 and a memory which is used as a work area when executing the programs (not shown in the drawings).

Further, the control unit 41 controls each unit by cooperation with a program stored in a program storage unit 431 of the storage unit 43.

The projector 42 is a projection device for converting image data output from the control unit 41 to projection light and projecting it towatd the screen unit 31.

For example, a DLP (Digital Light Processing; Registered Trademark) projector can be used as the projector 42. The DLP projector uses a DMD (Digital Micro-mirror Device) which is display device for switching on/off states at high speed by changing a tilt angle of each of a plurality of micro-mirrors (in the case of XGA, horizontal 1024 pixels x vertical 768 pixels) arranged in array and forming an optical image by light reflected from the micro-mirrors.

The storage unit 43 is formed by a HDD, a non-volatile semiconductor memory, or the like, and includes the program storage unit 431, an image data storage unit 432, and a voice data storage unit 433.

In the program storage unit 431, there are stored a system program and various processing programs executed by the control unit 41, and/or data necessary for execution of the programs.

In the image data storage unit 432, there is stored data of content moving picture which is displayed when playing back the content.

In the voice data storage unit 433, there is stored voice data for voice output of the content.

The communication unit 44 communicates with an external information terminal (not shown in the drawings), for example, and transmits/receives data.

The communication method is not limited to a specific one and can use a wireless connection by wireless LAN, Bluetooth (Registered Trademark), NFC, or the like, or a wired connection using a USB cable, for example.

The communication unit 44 functions as a data receiving unit for receiving data such as new content data, which will be displayed on the screen unit 31, to be stored in the image data storage unit 432 and/or the voice data storage unit 433.

In the following, it will be described how the display apparatus 10 according to the present embodiment works.

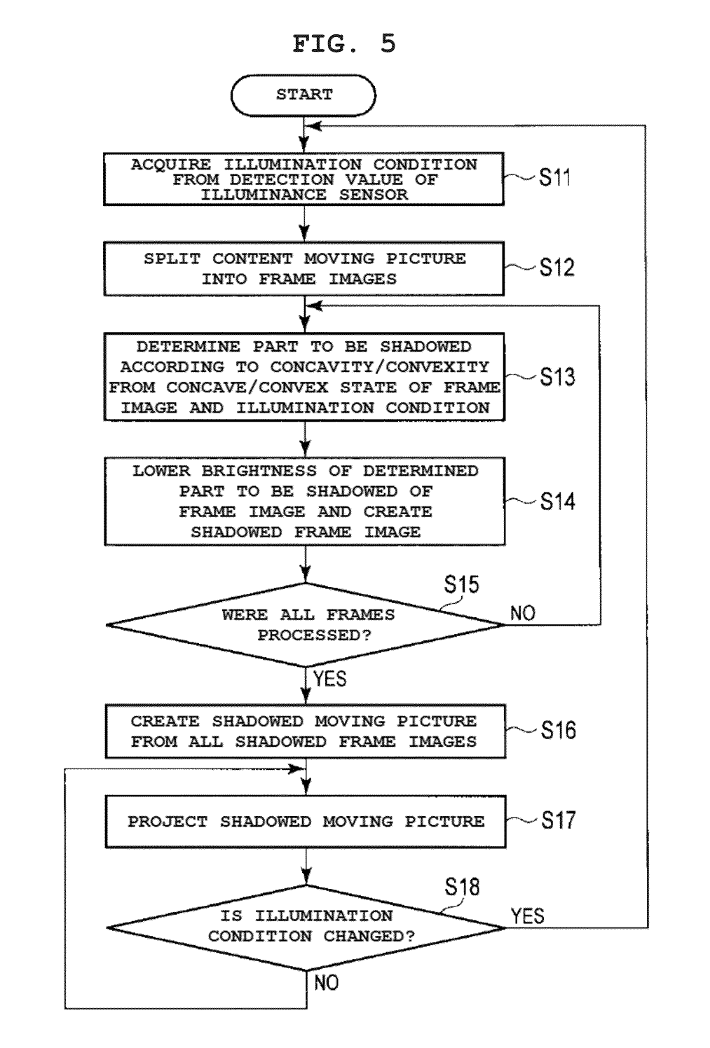

The control unit 41 of the display apparatus 10 performs display control according to a display control program as shown in a flow chart of FIG. 5 which is one of the processing programs stored in the program storage unit 431.

First, the control unit 41 acquires a present illumination condition (Step S11). This is performed by reading detection values of the illuminance sensors 47T, 47F, 47B, 47L and 47R.

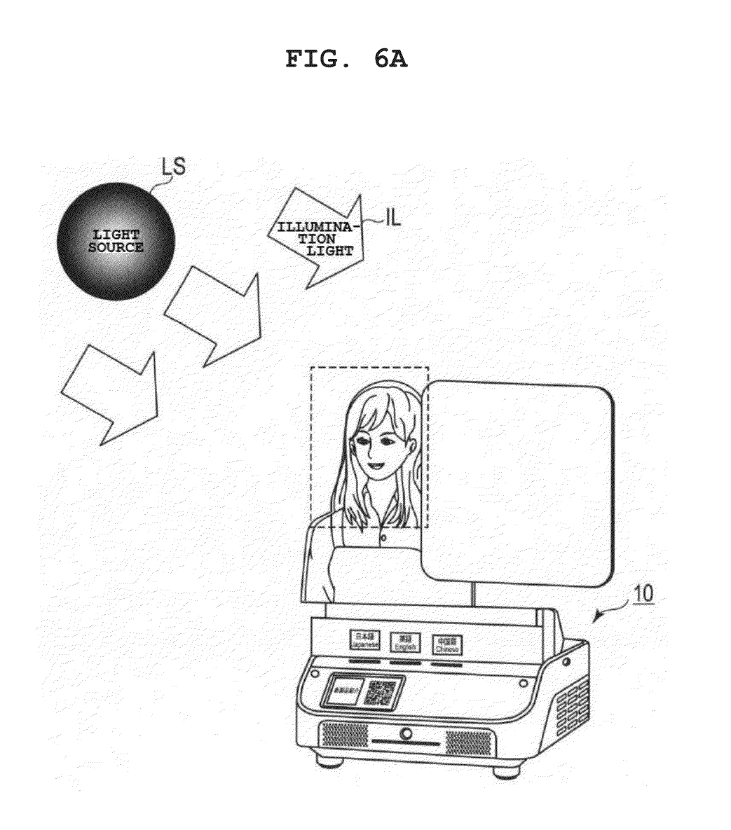

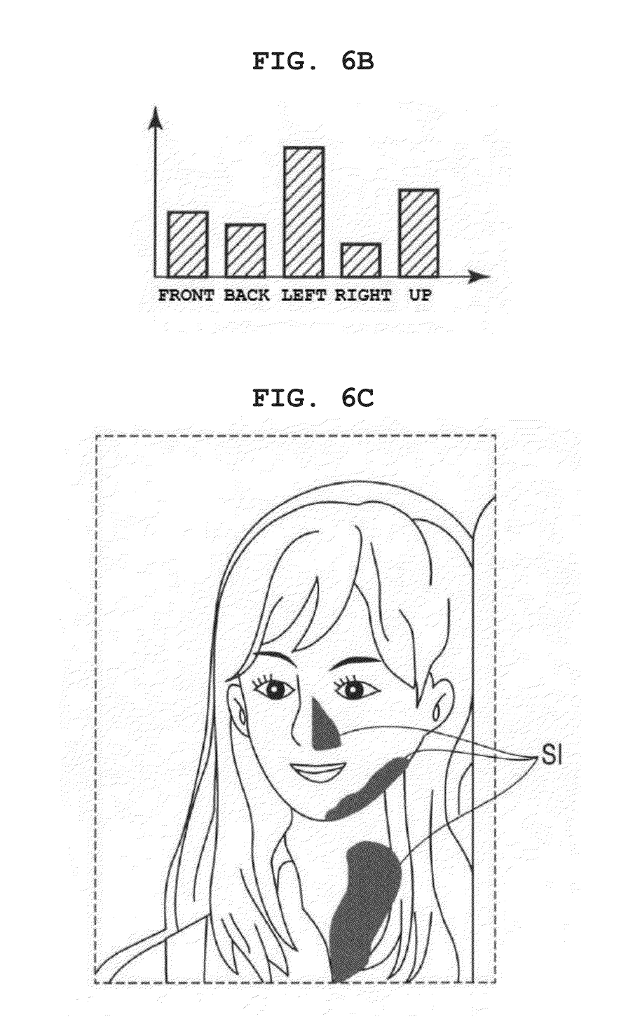

For example, in the case that the display apparatus 10 is installed in a position where a light source LS exists above and on the left of the display apparatus 10, as shown in FIG. 6A, the display apparatus 10 is illuminated by illumination light IL from the light source LS from above and left side. In this situation, detection values of the left illuminance sensor 47L and the top illuminance sensor 47T are larger and a detection value of the right illuminance sensor 47R is smaller than detection values of the front illuminance sensor 47F and the back illuminance sensor 47B, as shown in FIG. 6B. As described above, the direction in which the light source LS exists can be acquired as the illumination condition from the detection values of the illuminance sensors 47T, 47F, 47B, 47L and 47R.

In the present embodiment, the illumination condition is acquired by using the illuminance sensors 47T, 47F, 47B, 47L and 47R. However, the present invention is not limited thereto. In some embodiments, the illumination condition can be acquired by an image captured by at least one camera instead of the illuminance sensors 47T, 47F, 47B, 47L and 47R. In another embodiment, both of the illuminance sensors and the camera are used. In some embodiments, an installer of the display apparatus 10 can set the illumination condition by using the operating unit 45 or the illumination condition can be set by communication from the outside through the communication unit 44. In a particular embodiment, if the illumination condition of a location where the display apparatus 10 is installed is predetermined, the illumination condition is stored in the storage unit 43 during a manufacturing process of the display apparatus 10 or when shipping it. The illumination condition is acquired by reading it from the storage unit 43.

The illumination condition may include brightness (a luminance level) of the illumination light IL as well as the direction of the light source LS.

After the illumination condition is acquired, the control unit 41 splits the content moving picture data stored in the image data storage unit 432 on a frame image basis. The image data of each split frame image is stored in the image data storage unit 432 (Step S12).

Then, the control unit 41 reads the image data of one frame image from the image data storage unit 432 and, from a state of concavity-convexity represented by three-dimensional data of an object included in the frame image and the illumination condition acquired at Step S11, determines a part or parts to be shadowed of the frame image according to the concavity-convexity (Step S13). In other words, the control unit 41 determines a part or parts of the frame image which would be shadowed if a real object corresponding to the image projected onto the screen unit 31 existed in the position of the screen unit 31 and the object was illuminated by the illumination light IL from the light source LS.

More specifically, the control unit 41 acquires a three-dimensional shape of the object included in the image data of the frame image and determines the part(s) to be shadowed. The three-dimensional shape can be acquired by estimation from a shape of the object. In some embodiments, data of a real three-dimensional shape is incorporated in the image data in advance and the control unit 41 reads the data to acquire the three-dimensional shape.

After the part(s) to be shadowed are determined as described above, the control unit 41 creates shadowed frame image data by lowering brightness of the determined part(s) to be shadowed of the image data of the frame image and allows the shadowed frame image data to be stored in the image data storage unit 432 (Step S14). In the case that the brightness of the illumination light IL has also been acquired as an additional illumination condition, brightness of shadows can be adjusted according to the brightness of the illumination light IL.

Then, the control unit 41 determines whether or not Steps S13 and S14 were completed for the image data of all of the frame images acquired by splitting the content moving picture and stored in the image data storage unit 432 at step S12 (Step S15). In the case that the steps have not been completed for at least one of the frame images yet, the process returns to Step S13 and the control unit 41 repeats the steps for image data of the next frame image.

On the other hand, in the case that it is determined that the steps were completed for all of the frame images, the control unit 41 creates shadowed moving picture data from the image data of all of the shadowed frame images stored in the image data storage unit 432 and allows the shadowed moving picture data to be stored in the image data storage unit 432 (Step S16).

Then, the control unit 41 reads the shadowed moving picture data stored in the image data storage unit 432 and outputs it to the projector 42 to project and display the shadowed moving picture on the screen unit 31. At the same time, the control unit 41 reads the voice data stored in the voice data storage unit 433 and outputs it to the voice output unit 46. Thus, the voice is output so that it is synchronized with the shadowed moving picture which is being projected and displayed (Step S17). By this, as shown in FIG. 6C, the shadowed moving picture including shadow images SI according to the concavity-convexity of the image and the direction of the light source LS is displayed on the screen unit 31. Therefore, it is possible to display an image in which an object such as a human being having an uneven surface (with concavity and/or convexity) appears three-dimensional.

Then, the control unit 41 determines whether or not to change the illumination condition (Step S18). For example, in the case that the display apparatus 10 is installed in an outdoor environment or near a window even though it is in an indoor environment, the direction of the sun which is the light source LS changes over time. In this case, it is desirable to change the shadow image SI over time. For this, the time for changing the illumination condition is set in advance and, at Step S18, it is determined whether or not it is the time to change. Alternatively, in the case that the location in which the display apparatus 10 is installed can be changed even though the light source LS is indoor light, it is desirable to change the shadow image SI according to the direction of the light source LS in the changed installation location. For this, at Step S18, it is determined whether or not the operating unit 45 is manipulated to issue an instruction to change the illumination condition.

It is determined at Step S18 that the illumination condition is not changed, the control unit 41 returns the process to Step S17 and continues to project the shadowed moving picture.

On the other hand, it is determined at Step S18 that the illumination condition is changed, the control unit 41 returns the process to Step S11 and repeats the above steps to acquire a new illumination condition and project new shadowed moving picture according to the new illumination condition.

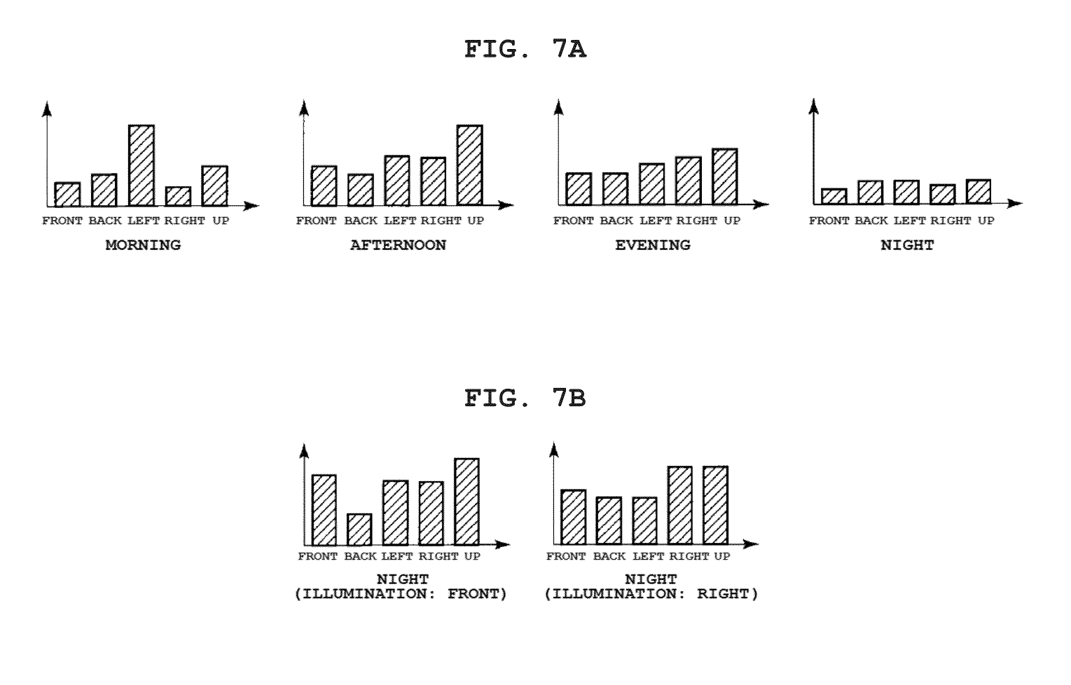

FIG. 7A shows an example of outputs of the illuminance sensors 47T, 47F, 47B, 47L and 47R in the case that the illumination condition is changed over time. FIG. 7B shows an example of outputs of the illuminance sensors 47T, 47F, 47B, 47L and 47R in the case that the installation location and the illumination condition are changed.

As described above, the control unit 41 of the display apparatus 10 according to the first embodiment acquires the illumination condition(s) including at least the direction of the light source LS existing outside the display apparatus 10 from the detection values of the illuminance sensors 47T, 47F, 47B, 47L and 47R, determines the part(s) to be shadowed of the image to be displayed based on the illumination condition(s), and generates the shadowed image by adding the shadow(s) to the part(s) of the image. The projector 42 of the display apparatus 10 projects the shadowed image as generated above onto the screen unit 31 to display it. Therefore, the display apparatus 10 can display an image in which an object such as a human being having an uneven surface (with concavity and/or convexity) appears three-dimensional.

In the present embodiment, the determination of the part(s) to be shadowed is based on the concave-convex state of an object included in the image to be displayed in addition to the illumination condition(s). Thus, it is possible to display the shadowed image to which the shadow image SI has been added according to the concave-convex state of the object without a sense of incongruity.

According to the present embodiment, the shadow image is generated by lowering the brightness of the part(s) to be shadowed of the image to be displayed. Therefore, the shadowed image can be displayed even in the case that the projector 42 cannot display the black color.

Further, since the direction of the light source LS is detected based on the detection values of the plurality of illuminance sensors 47T, 47F, 47B, 47L and 47R for detecting illuminance in a plurality of directions with respect to the display apparatus 10, the direction of the light source LS can be easily detected.

In another embodiment, the direction of the light source LS is detected from an image captured by a camera. Thus, the direction of the light source LS can be easily detected.

In the case the brightness of the illumination light IL can be acquired, concentrations of the shadows can be changed based on the brightness.

Further, in some embodiments, it is determined whether or not the original image includes a shadow or shadows by using a proper image analysis method. In the case the original image includes the shadow(s), a process for deleting one or more (unnecessary) shadow (i.e. a correction process) is performed and new shadows are added as described above.

### Second Embodiment

Next, a second embodiment of the present invention will be described. Aspects of the second embodiment that are different from the first embodiment are mainly described hereafter. Elements the same as or equivalent to those of the display apparatus 10 of the first embodiment are designated by the same reference numerals and descriptions thereof will be omitted.

According to the first embodiment, a position in which the shadow image SI is displayed is determined based on the three-dimensional data of the object included in the content moving picture. The three-dimensional part 332 originally has concavity and/or convexity formed based on three-dimensional data relating to the shape of the three-dimensional part 332. Thus, the second embodiment of the present invention is configured to determine the position in which the shadow image SI is displayed based on the concavity-convexity of the screen unit 31.

More specifically, data showing a concave-convex configuration of the screen unit 31 is stored in the storage unit 43. Since the screen unit 31 is exchangeable as described above, it is required to store data showing the concave-convex configuration of each of a plurality of screen units 31 in the storage unit 43 in advance and makes it possible to set information for specifying a screen unit 31 which is presently being attached by setting through the operating unit 45 or communication via the communication unit 44. In another embodiment, the kind of each screen unit 31 can be detected mechanically or optically and thus the display apparatus 10 can specify the kind of the screen unit 31. In this case, there may be stored data showing the concave-convex configuration of each screen unit 31 in the screen unit 31 (for example, in a storage device included in the screen unit 31) and the display apparatus 10 may read the data.

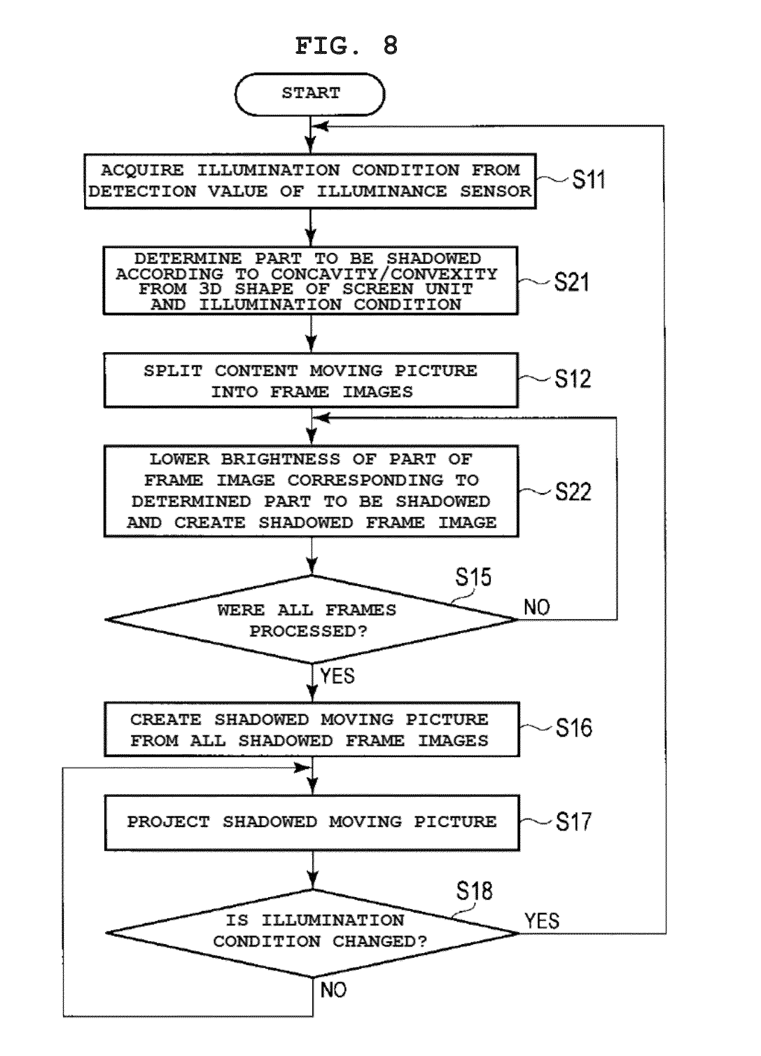

Now, it is described how the display apparatus of the second embodiment works. As shown in a flow chart of FIG. 8, the control unit 41 first acquires the present illumination condition including at least the direction of the light source LS from the detection values of the illuminance sensors 47T, 47F, 47B, 47L and 47R, and the like, similarly to the first embodiment (Step S11).

Then, according to the present embodiment, the control unit 41 reads the data showing the concave-convex configuration of the screen unit 31 from the storage unit 43 or the screen unit 31 and, from the concave-convex configuration of the screen unit 31 and the illumination condition acquired at Step S11, determines a part or parts of the screen unit 31 on which a shadow or shadows are cast to correspond to the concavity-convexity (Step S21).

Then, the control unit 41 splits the content moving picture data stored in the image data storage unit 432 on a frame image basis. The image data of each split frame image is stored in the image data storage unit 432 (Step S12).

Then, the control unit 41 reads the image data of one frame image from the image data storage unit 432 and creates a shadowed frame image by lowering brightness of a part or parts of the frame image corresponding to the part(s) of the screen unit 31 on which it is determined that the shadow(s) are cast. The data of the shadowed frame image is stored in the image data storage unit 432 (Step S22).

Then, the control unit 41 determines whether or not Step S22 was completed for the image data of all of the frame images acquired by splitting the content moving picture and stored in the image data storage unit 432 at step S12 (Step S15). In the case that the step has not been completed for at least one of the frame images yet, the process returns to Step S22. On the other hand, in the case that it is determined that the step was completed for all the frame images, the process proceeds to Step S16 as described with respect to the first embodiment.

As described above, in the second embodiment, the determination of the part(s) to be shadowed is based on the concave-convex configuration of the screen unit 31 including the three-dimensional part 331 in addition to the illumination condition. Thus, it is possible to display the shadowed image to which the shadow image(s) SI have been added according to the concave-convex configuration of the three-dimensional part 331 of the screen unit 31 without the sense of incongruity.

Further, since the concavity-convexity configuration of the screen is formed based on the concave-convex state of the object included in the image to be displayed, it is possible to display the shadowed image to which the shadow(s) have been added according to the concave-convex state of the object without the sense of incongruity.

### Third Embodiment

Hereinafter, a third embodiment of the present embodiment will be described.

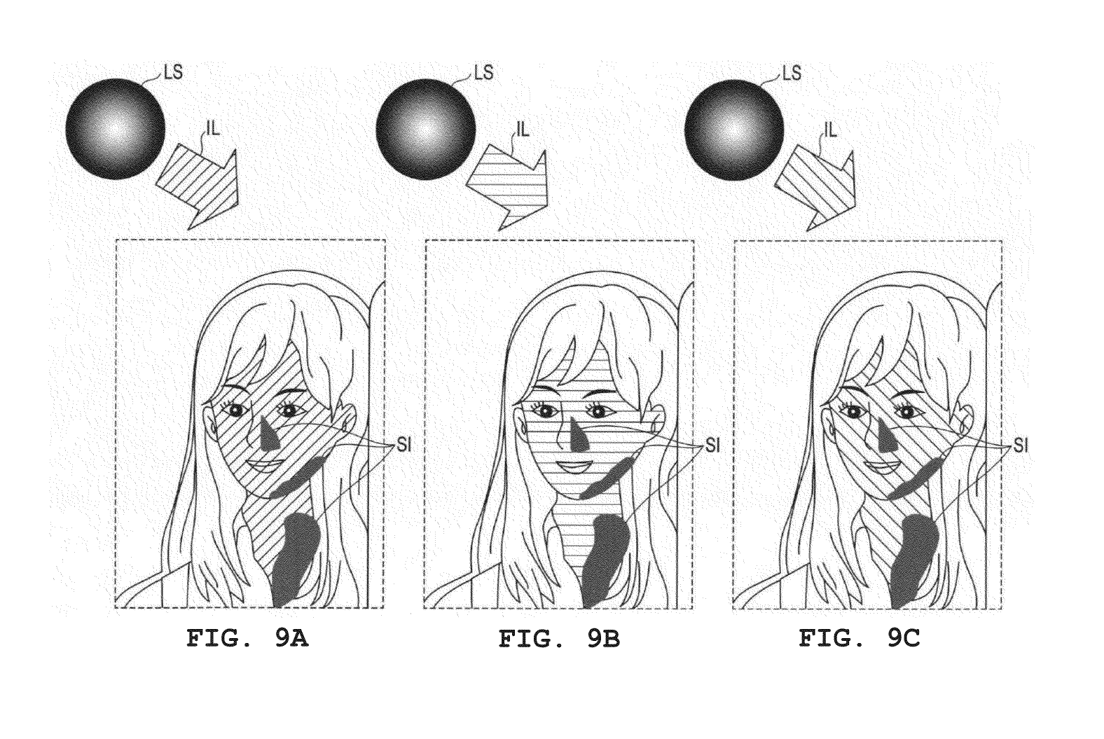

In the first and second embodiments, the shadowed moving picture based on the acquired illumination condition is projected and displayed. In addition, as shown in FIGS. 9A to 9C, a color of the image including the shadow images SI can be adjusted according to a color (temperature) of the illumination light IL.

In this case, the color of the illumination light IL as well as the direction of the light source LS are acquired as the illumination conditions at Step S11 as described with respect to the first and second embodiments. Further, when the shadowed frame image is created at Step S14 or S22 as described above, its color is adjusted.

As described above, according to the third embodiment, the color of the illumination light IL for the display apparatus 10 is acquired as one of the illumination conditions and the color of the image to be displayed is adjusted according to the color of the illumination light IL. Therefore, it is possible to display an image providing the strong impression of reality.

### Fourth Embodiment

Next, a fourth embodiment of the present invention will be described. Aspects of the fourth embodiment that are different from the first embodiment are mainly described hereafter. Elements the same as or equivalent to those of the display apparatus 10 of the first embodiment are designated by the same reference numerals and descriptions thereof will be omitted.

In the first embodiment, the display apparatus 10 generates the shadowed moving picture data. However, in the fourth embodiment, the shadowed moving picture data is generated outside the display apparatus 10.

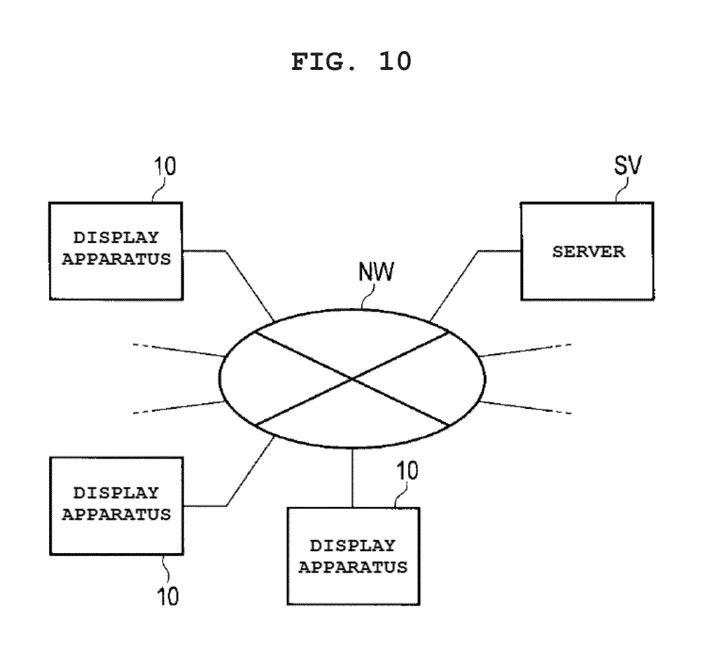

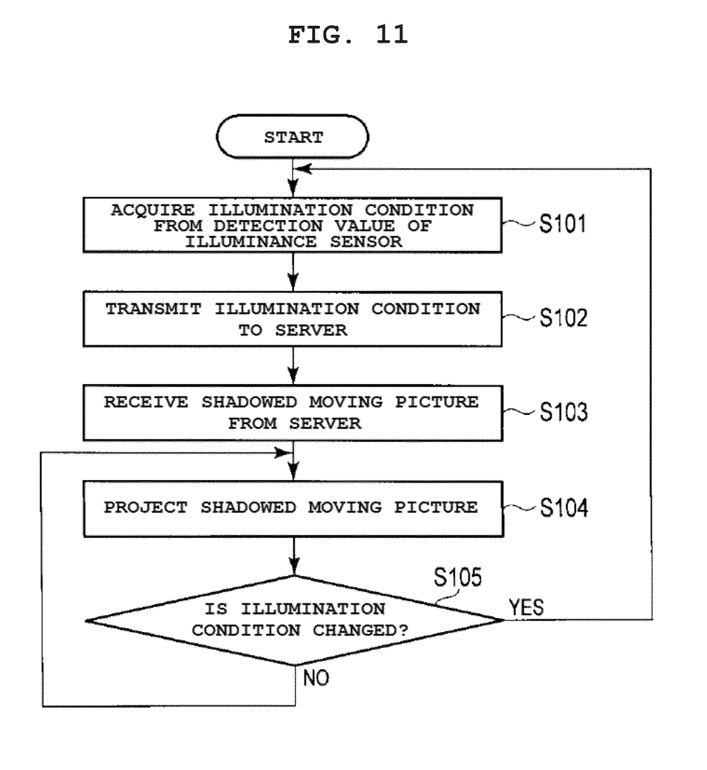

As shown in FIG. 10, a display system is configured where a plurality of display apparatuses 10 are connected to an external server SV via a network NW such as the wireless LAN or the Internet.

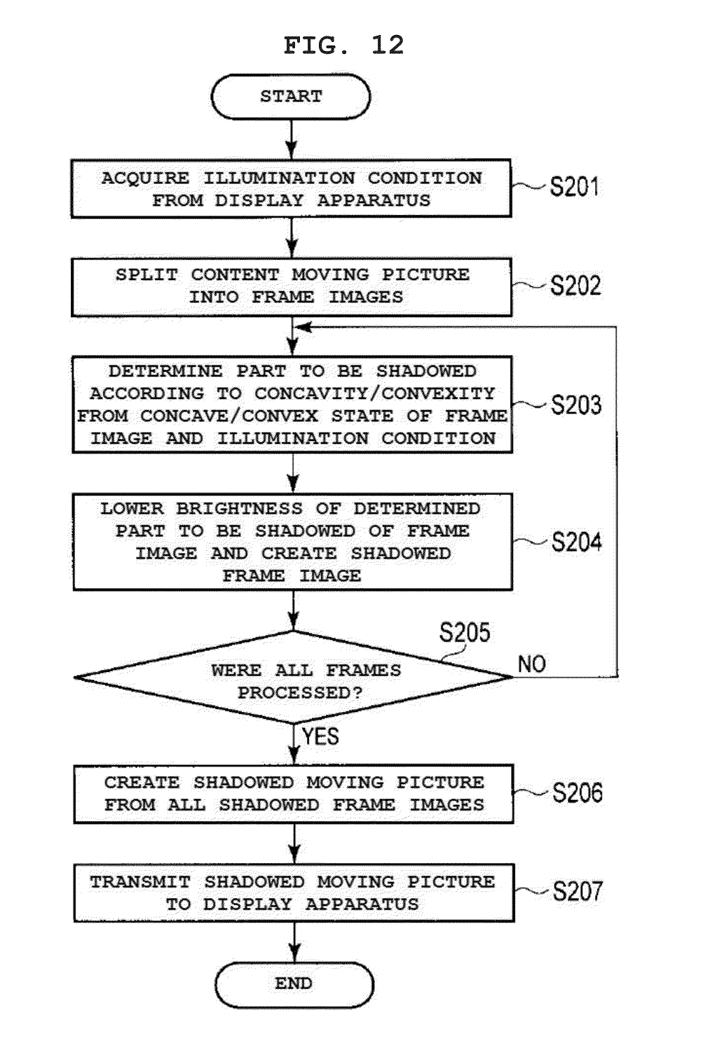

The control unit 41 of each of the plurality of display apparatuses 10 acquires the present illumination condition including at least the direction of the light source LS from the detection values of the illuminance sensors 47T, 47F, 47B, 47L and 47R, and the like, as shown in a flow chart of FIG. 11 (Step S101).

Then, the control unit 41 transmits the acquired illumination condition to server SV by the communication unit 44 via the network NW (Step S102).

As shown in a flow chart of FIG. 12, a control unit of the server SV (not shown in the drawings) acquires the illumination condition of the display apparatus 10 which is a transmission source by receiving the illumination condition transmitted from the display apparatus 10 (Step S201).

The control unit of the server SV splits content moving picture data stored in it, which is to be displayed by the display apparatus 10, on a frame image basis (Step S202).

Then, from a state of concavity-convexity represented by three-dimensional data of an object included in the image data of one of the split frame images and the illumination condition acquired at Step S201, the control unit of the server SV determines a part or parts to be shadowed of the image data of the frame image according to the concavity-convexity (Step S203).

If the part(s) to be shadowed are determined as described above, the control unit of the server SV creates shadowed frame image data by lowering brightness of the determined part(s) to be shadowed of the image data of the frame image (Step S204).

Then, the control unit of the server SV determines whether or not Steps S203 and S204 were completed for the image data of all of the frame images acquired by splitting the content moving picture data at step S202 (Step S205). In the case that the steps have not been completed for at least one of the frame images yet, the process returns to Step S203 and repeats the steps for image data of the next frame image.

On the other hand, in the case that it is determined at Step 205 that the steps were completed for all the frame images, the control unit of the server SV creates shadowed moving picture data from the image data of all of the shadowed frame images created at Step S204 (Step S206).

Then, the control unit of the server SV transmits the created shadowed moving picture data and corresponding voice data to a corresponding display apparatus 10 via the network NW (Step S207). After that, the process ends.

The control unit 41 of the display apparatus 10 receives the created shadowed moving picture data and the voice data transmitted from the server SV via the network NW by the communication unit 44 and allows the shadowed moving picture data and the voice data to be stored in the image data storage unit 432 and the voice data storage unit 433, respectively (Step S103).

Then, the control unit 41 reads the shadowed moving picture data stored in the image data storage unit 432 and outputs it to the projector 42 to project and display the shadowed moving picture on the screen unit 31. At the same time, the control unit 41 reads the voice data stored in the voice data storage unit 433 and outputs it to the voice output unit 46. Thus, the voice is output so that it is synchronized with the shadowed moving picture which is being projected and displayed (Step S104).

Then, the control unit 41 determines whether or not to change the illumination condition (Step S105). It is determined at Step S105 that the illumination condition is not changed, the control unit 41 returns the process to Step S104 and continues to project the shadowed moving picture. On the other hand, it is determined at Step S18 that the illumination condition is changed, the control unit 41 returns the process to Step S101 and acquires a new illumination condition.

In the present embodiment, the server SV performs the determination of the part(s) to be shadowed and the generation of the shadowed moving picture. However, the server does not necessarily need to perform both of the functions (i.e. the determination of the part(s) to be shadowed and the generation of the shadowed moving picture) and it is sufficient for the server SV to perform at least one of the functions. The function which the server SV does not perform can be performed by the display apparatus 10 as described with respect to the first to third embodiments.

In another embodiment, the control unit of the server (not shown in the drawings) can determine the position in which the shadow image SI is displayed, not based on the three-dimensional data of the object included in the content moving picture data, but based on the concave-convex configuration of the screen unit 31 of the display apparatus 10, as described above with respect to the second embodiment. In this case, the control unit of the server SV needs to store the concave-convex configuration of the screen unit 31 of each display apparatus 10 therein in advance or the display apparatus 10 needs to transmit it to the server SV.

Further, the color of the image can also be adjusted as described with respect to the third embodiment.

As described above, according to the fourth embodiment, the display apparatus 10 includes the communication unit 44 which enables communication with the server SV via the network NW and the server SV performs at least one of the functions of determining the part(s) to be shadowed and generating the shadowed image. Thus, the control unit 41 of the display apparatus 10 does not require so much processing capability. Therefore, a cheap display apparatus can be provided.

Although the present invention was described above by way of the embodiments, the present invention is not limited to the embodiments described above and various modifications can be made without departing from the spirit and scope of the invention.

For example, according to the first, the third and the fourth embodiments, the screen unit 31 includes the three-dimensional part 332 having the concavity-convexity. However, even in the case that the screen unit 31 is a flat screen which includes only the flat panel part 331, it is possible to create a more three-dimensional effect by projecting and displaying the shadowed image including the shadow image(s) SI.

Further, the first to fourth embodiments were described by using the display apparatus 10 which is a projection-type display apparatus. However, the present invention can be applied to a see-through type display apparatus in the same way.

The controls described by using mainly the flow chart of each of the embodiments described above can be realized by a program. This program can be stored in a recording medium or a recording unit. Various ways can be used to record the program on the recording medium or the recording unit. The program may be recorded during before product shipping. Alternatively, the program may be recorded on a distributed recording medium or downloaded via the Internet.

What is claimed is:

1. A display apparatus comprising:
a display section;
an illumination condition acquiring section configured to acquire an illumination condition including at least the direction of an external light source with respect to the display section;
a corrected image generating section configured to generate a corrected image based on the illumination condition and an image to be displayed; and
a display control section configured to perform control to display the corrected image on the display section.

2. The display apparatus of claim 1 further comprising a determining section configured to determine a shadow part of the image to be displayed which is to be shadowed based on the illumination condition,
wherein the corrected image generating section generates a shadowed image by adding a shadow to the shadow part of the image to be displayed.

3. The display apparatus of claim 2, wherein the determining section determines the shadow part based on a concave-convex state of an object included in the image to be displayed in addition to the illumination condition.

4. The display apparatus of claim 2, wherein the display section comprises a screen including a three-dimensional part and a projection section configured to project an image onto the screen, and
the determining section determines the shadow part based on a concave-convex configuration of the three-dimensional part of the screen in addition to the illumination condition.

5. The display apparatus of claim 4, wherein the concave-convex configuration of the screen is formed based on a concave-convex state of an object included in the image to be displayed.

6. The display apparatus of claim 2, wherein the corrected image generating section generates a shadow image within the image to be displayed by lowering brightness of the shadow part of the image to be displayed.

7. The display apparatus of claim 1, wherein the illumination condition acquiring section comprises a plurality of illuminance sensors for detecting illuminance in a plurality of directions with respect to the display apparatus and a direction detecting section configured to detect the direction of the light source based on detection values of the plurality of illuminance sensors.

8. The display apparatus of claim 1, wherein the illumination condition acquiring section comprises a camera and a direction detecting section configured to detect the direction of the light source from an image captured by the camera.

9. The display apparatus of claim 1, wherein the illumination condition acquiring section comprises a color detecting section configured to detect a color of illumination light for the display apparatus as one illumination condition, and
the corrected image generating section comprises a color adjusting section configured to adjust a color of the image to be displayed based on the color of the illumination light.

10. A display system comprising:
a display apparatus; and
a server in which an image is stored,
wherein the display apparatus comprises:
a display section;
an illumination condition acquiring section configured to acquire an illumination condition including at least the direction of an external light source with respect to the display section;
a communication section configured to communicate with the server via a network; and
a display control section configured to perform control to display a corrected image received by the communication section from the server on the display section, and
the communication section transmits the illumination condition to the server, and
the server generates the corrected image based on the illumination condition and the image and transmits the corrected image to the display apparatus.

11. The display apparatus of claim 1, wherein the corrected image generating section determines whether or not the image to be displayed includes a shadow cast on a part of it, and,
in the case that it is determined that the image to be displayed includes a shadow cast on a part of it, the corrected image generating section deletes the shadow and adds a shadow to the part of the image to be displayed to generate a shadowed image.

12. A display control method performed by a display apparatus comprising:
acquiring an illumination condition including at least the direction of a light source existing outside the display apparatus;
determining a shadow part of an image to be displayed which is to be shadowed based on the illumination condition;
generating a shadowed image by adding a shadow to the shadow part of the image to be displayed; and
displaying the shadowed image.

13. A non-transitory computer-readable recording medium for recording a program readable by a computer, the program causing a computer included in a display apparatus to perform steps of:
acquiring an illumination condition including at least the direction of a light source existing outside the display apparatus;
determining a shadow part of an image to be displayed which is to be shadowed based on the illumination condition;
generating a shadowed image by adding a shadow to the shadow part of the image to be displayed; and
displaying the shadowed image.

14. A display system comprising:
a display apparatus; and
a server,
wherein the display apparatus comprises:
a display section;
an illumination condition acquiring section configured to acquire an illumination condition including at least the direction of an external light source with respect to the display section;
a communication section configured to communicate with the server via a network;
a corrected image generating section configured to generate a corrected image by correcting an image; and
a display control section configured to perform control to display the corrected image on the display section, and
the communication section transmits the illumination condition to the server,
the server determines a shadow part of the image based on the illumination condition, and
the corrected image generating section generates a shadowed image by adding a shadow to the shadow part of the image as the corrected image.
